(19) United States
(12) Patent Application Publication
(10) Pub. No.: US 2022/0414712 A1
(43) Pub. Date: Dec. 29, 2022

(54) METHOD AND SYSTEM FOR PROVIDING BENEFITS FOR APPLICATION, AND NON-TRANSITORY COMPUTER-READABLE RECORDING MEDIUM

(71) Applicant: Sang Duck CHOI, Seoul (KR)

(72) Inventor: Sang Duck CHOI, Seoul (KR)

(21) Appl. No.: 16/651,489

(22) PCT Filed: Sep. 27, 2018
(86) PCT No.: PCT/KR2018/011379

§ 371 Date: Jun. 5, 2020

(30) Foreign Application Priority Data
Sep. 27, 2017 (KR) 10-2017-0125314

(51) Int. Cl. G06Q 30/02; G01C 21/34

(52) U.S. Cl. CPC G06Q 30/0261; G01C 21/3453

(57) ABSTRACT

According to one aspect of the present invention, there is provided a method for providing benefits for an application, the method comprising the steps of: acquiring information on an optimal travel route of a user; and when a place associated with benefits for at least one application is included in an actual travel route of the user, determining the benefits to be provided to the user with reference to a difference between the optimal travel route and the actual travel route.

### CROSS-REFERENCE TO RELATED APPLICATION(S)

This application is a continuation application of Patent Cooperation Treaty (PCT) International Application No. PCT/KR2018/011379 filed on Sep. 27, 2018, which claims priority to Korean Patent Application No. 10-2017-0125314 filed on Sep. 27, 2017. The entire contents of PCT International Application No. PCT/KR2018/011379 and Korean Patent Application No. 10-2017-0125314 are hereby incorporated by reference.

### FIELD OF THE INVENTION

The present invention relates to a method, system, and non-transitory computer-readable recording medium for providing benefits for an application.

### BACKGROUND

In recent years, benefits for an application such as game items have been provided to visitors of a certain place.

As one example of related conventional techniques, there has been introduced a technique for providing an item that can be obtained only at a specific location when a user using a character rearing service accesses the character rearing service at the specific location, by interworking a character rearing server with a location-based server.

However, according to the techniques introduced so far, including the above conventional technique, benefits are provided in monotonous and flat manners at any time and anywhere, without discriminating a user who comes from a near location, a user who comes from a distant location, and the like.

In this connection, the inventor(s) present a technique for taking account of a difference between an optimal travel route and an actual travel route of a user and providing the user with corresponding benefits.

### SUMMARY OF THE INVENTION

One object of the present invention is to solve all the above-described problems in the prior art.

Another object of the invention is to take account of a spent time, a traveled distance, and the like of a user and provide the user with corresponding benefits for an application.

Yet another object of the invention is to provide a recommended travel route including a place associated with benefits for an application.

Still another object of the invention is to provide different benefits for each point of time when a user visits a place associated with benefits for an application.

Still yet another object of the invention is to provide different benefits according to a period of time for which a user stays in a place associated with benefits for an application.

Further another object of the invention is to provide marketing information for a place associated with benefits for an application together with the benefits.

The representative configurations of the invention to achieve the above objects are described below.

According to one aspect of the invention, there is provided a method for providing benefits for an application, the method comprising the steps of: acquiring information on an optimal travel route of a user; and when a place associated with benefits for at least one application is included in an actual travel route of the user, determining the benefits to be provided to the user with reference to a difference between the optimal travel route and the actual travel route.

According to another aspect of the invention, there is provided a system for providing benefits for an application, the system comprising: an information acquisition unit configured to acquire information on an optimal travel route of a user; and a benefit determination unit configured to, when a place associated with benefits for at least one application is included in an actual travel route of the user, determine the benefits to be provided to the user with reference to a difference between the optimal travel route and the actual travel route.

In addition, there are further provided other methods and systems to implement the invention, as well as non-transitory computer-readable recording media having stored thereon computer programs for executing the methods.

According to the invention, it is possible to take account of a spent time, a traveled distance, and the like of a user and provide the user with corresponding benefits for an application.

According to the invention, it is possible to provide different benefits for each point of time when a user visits a place associated with benefits for an application.

According to the invention, it is possible to provide a recommended travel route including a place associated with benefits for an application.

According to the invention, it is possible to provide marketing information for a place associated with benefits for an application together with the benefits.

According to the invention, it is possible to provide different benefits according to a period of time for which a user stays in a place associated with benefits for an application.

### BRIEF DESCRIPTION OF THE DRAWINGS

FIG. 1 schematically shows the configuration of an entire system for providing benefits for an application according to one embodiment of the invention.

FIG. 2 illustratively shows the internal configuration of a benefit provision system according to one embodiment of the invention.

FIG. 3 illustratively shows a situation in which benefits for an application are provided according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Configuration of the Entire System

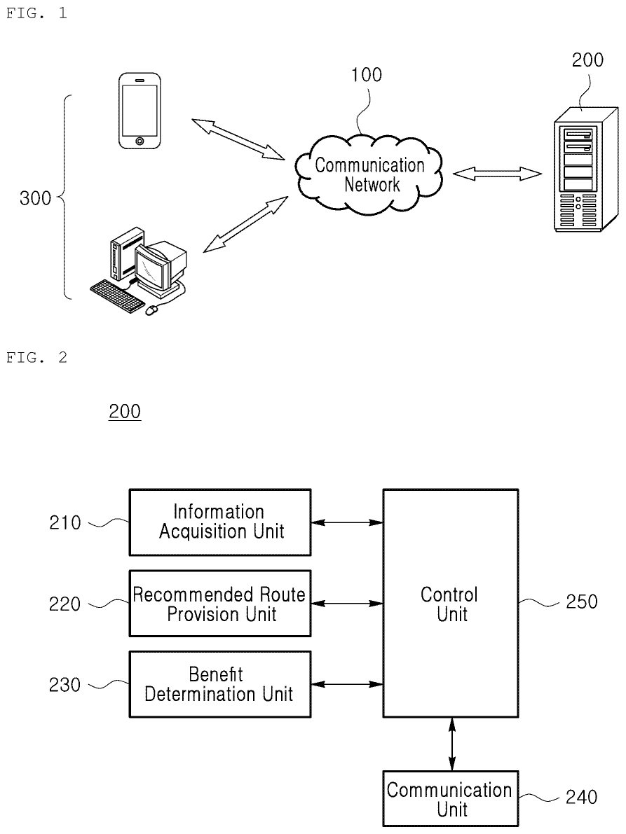

FIG. 1 schematically shows the configuration of the entire system for providing benefits for an application according to one embodiment of the invention.

As shown in FIG. 1, the entire system according to one embodiment of the invention may comprise a communication network 100, a benefit provision system 200, and a user device 300.

First, the communication network 100 according to one embodiment of the invention may be configured regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, Bluetooth communication (e.g., Bluetooth Low Energy (BLE) communication), infrared communication, and ultrasonic communication.

Next, the benefit provision system 200 according to one embodiment of the invention may communicate with the user device 300 to be described below via the communication network 100, and may function to acquire information on an optimal travel route of a user, and when a place associated with benefits for at least one application is included in an actual travel route of the user, determine the benefits to be provided to the user with reference to a difference between the optimal travel route and the actual travel route.

Meanwhile, the travel route according to one embodiment information may encompass information on detailed routes such as a left or right side of a road, a crossing, and an overpass.

The configurations and functions of the benefit provision system 200 according to the invention will be discussed in more detail below. Meanwhile, although the benefit provision system 200 has been described as above, the above description is illustrative and it will be apparent to those skilled in the art that at least a part of the functions or components required for the benefit provision system 200 may be implemented or included in the user device 300 or an external system (not shown), as necessary.

Next, the user device 300 according to one embodiment of the invention is digital equipment that may function to connect to and then communicate with the benefit provision system 200 via the communication network 100, and any type of portable digital equipment having a memory means and a microprocessor for computing capabilities, such as a smart phone and a tablet PC, may be adopted as the user device 300 according to the invention. Further, the user device 300 according to one embodiment of the invention may also include a GPS module (not shown) for identifying the user's location.

Meanwhile, according to one embodiment of the invention, the user device 300 may include an application capable of transferring information on the optimal travel route and actual travel route of the user to the benefit provision system 200, or providing the user with the benefits for the at least one application provided from the benefit provision system 200. The application may be downloaded from the benefit provision system 200 or an external application distribution server (not shown).

Configuration of the Benefit Provision System

Hereinafter, the internal configuration of the benefit provision system 200 crucial for implementing the invention and the functions of the respective components thereof will be discussed.

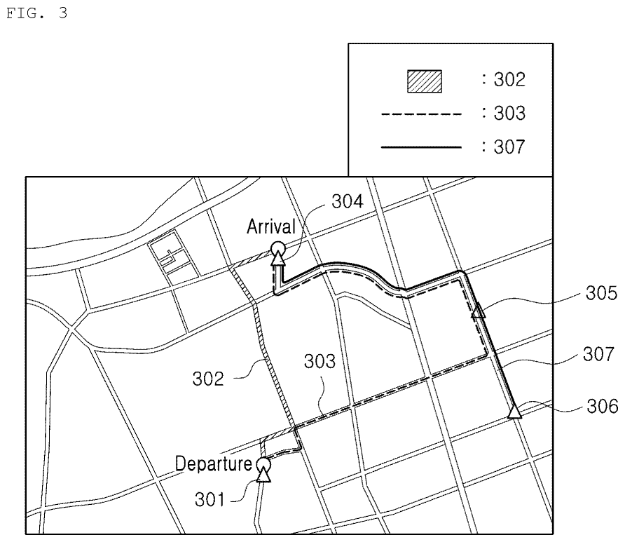

FIG. 2 illustratively shows the internal configuration of the benefit provision system 200 according to one embodiment of the invention.

As shown in FIG. 2, the benefit provision system 200 may comprise an information acquisition unit 210, a recommended route provision unit 220, a benefit determination unit 230, a communication unit 240, and a control unit 250. According to one embodiment of the invention, at least some of the information acquisition unit 210, the recommended route provision unit 220, the benefit determination unit 230, the communication unit 240, and the control unit 250 may be program modules to communicate with an external system. The program modules may be included in the benefit provision system 200 in the form of operating systems, application program modules, and other program modules, while they may be physically stored in a variety of commonly known storage devices. Further, the program modules may also be stored in a remote storage device that may communicate with the benefit provision system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the information acquisition unit 210 may acquire information on an optimal travel route of a user. According to one embodiment of the invention, the optimal travel route herein may mean information produced by a known optimal travel route search algorithm, such as a shortest route from the user's origin (or current location) to a destination desired by the user, or a minimum transit route for public transportation.

For example, the user device 300 may acquire information on the user's destination with reference to context information on at least one of the user's schedule, travel pattern, text chats, messages, social networking service (SNS) chats, and e-mail, and may produce the user's optimal travel route using information on the user's current location and destination. The information acquisition unit 210 according to one embodiment of the invention may acquire information on the user's optimal travel route from the user device 300.

Next, according to one embodiment of the invention, the recommended route provision unit 220 may provide the user with information on a recommended travel route including a place associated with benefits for at least one application, with reference to the acquired information on the user's optimal travel route. According to one embodiment of the invention, the above application may include various applications such as a game application, a fitness application, a shopping application, and a learning application. Further, according to one embodiment of the invention, the benefits for the application may include information on at least one of characters, items, coupons, discounts, service use, and service sharing.

Specifically, according to one embodiment of the present invention, the recommended route provision unit 220 may provide the user with the information on the recommended travel route including the place associated with the benefits for the at least one application, with reference to at least one of a distance to be traveled, a time required, and a level of benefits to be provided when the user visits the place associated with the benefits for the at least one application while traveling through the optimal travel route. Here, according to one embodiment of the invention, ranges of criteria for the distance to be traveled, the time required, and the level of benefits to be provided may be set by the user.

Meanwhile, according to one embodiment of the invention, the recommended route provision unit 220 may provide the user with the information on the recommended travel route, with reference to whether a partnership is established with the at least one application or the place associated with the benefits for the at least one application.

For example, according to one embodiment of the invention, the recommended route provision unit 220 may preferentially provide the user with information on a recommended travel route including a place with the partnership among places associated with the benefits for the at least one application.

Next, according to one embodiment of the invention, when the place associated with the benefits for the at least one application is included in an actual travel route of the user, the benefit determination unit 230 may determine the benefits to be provided to the user with reference to a difference between the optimal travel route and actual travel route of the user.

Specifically, according to one embodiment of the invention, when the place associated with the benefits for the at least one application is included in the user's actual travel route, the benefit determination unit 230 may increase a level of the benefits for the at least one application as the difference between the user's optimal travel route and actual travel route increases. According to one embodiment of the invention, the difference between the optimal travel route and actual travel route may be calculated in consideration of an actual distance difference, a straight-line distance difference, a travel time difference, and the like.

Meanwhile, according to one embodiment of the invention, the benefit determination unit 230 may determine whether the place associated with the benefits for the application is included in the user's actual travel route, with reference to a lookup table for a latitude, a longitude, or an address corresponding to the place associated with the benefits for the application.

Further, according to one embodiment of the invention, the benefit determination unit 230 may determine the benefits to be provided to the user with further reference to a point of time when the place associated with the benefits for the application is included in the user's actual travel route.

Specifically, according to one embodiment of the invention, the benefit determination unit 230 may differently determine the benefits to be provided to the user according to a point of time when the place associated with the benefits for the at least one application is included in the user's actual travel route.

For example, according to one embodiment of the invention, the benefit determination unit 230 may differently determine the benefits to be provided to the user when a certain place associated with the benefits for the at least one application is included in the user's actual travel route on Jul. 27, 2017, and the benefits to be provided to the user when the certain place associated with the benefits for the at least one application is included in the user's actual travel route on Jul. 28, 2017.

Meanwhile, according to one embodiment of the invention, the benefit determination unit 230 may cause the benefits to be provided to the user with reference to a lookup table for benefits corresponding to a place associated with the benefits for the application and a point of time when the place is included in the user's actual travel route.

Further, according to one embodiment of the invention, the benefit determination unit 230 may determine the benefits to be provided to the user with further reference to a period of time for which the user stays in the place associated with the benefits for the at least one application.

For example, according to one embodiment of the invention, the benefit determination unit 230 may increase a level of the benefits to be provided to the user as the period of time for which the user stays in the place associated with the benefits for the at least one application increases, and may not increase the level of the benefits any more when the period of time reaches a certain level.

Meanwhile, according to one embodiment of the invention, the benefit determination unit 230 may identify an exact indoor location in the place where the user stays, using a known indoor positioning technique employing Wi-Fi, Bluetooth (e.g., Bluetooth Low Energy (BLE)), Li-Fi, and the like.

Further, according to one embodiment of the invention, when the place associated with the benefits for the at least one application is included in the user's actual travel route, the benefit determination unit 230 may further determine marketing information for the place, which is to be provided together with the benefits for the application. According to one embodiment of the invention, the marketing information may include information on a product sold at the place associated with the benefits for the application (e.g., a discount or event for the product), information on a service available at the place, and the like.

Meanwhile, according to one embodiment of the invention, the benefit determination unit 230 may predetermine the benefits to be provided to the user with reference to a route through which the user is expected to actually travel (e.g., the recommended travel route).

For example, according to one embodiment of the invention, the benefit determination unit 230 may predetermine a level of benefits that may be provided to the user, with reference to the recommended travel route provided to the user before the user actually travels, and may determine the predetermined level of benefits as the benefits to be provided to the user when the user travels through the recommended travel route so that the actual travel route coincides with the recommended travel route. That is, in this case, the level of benefits determined on the basis of the difference between the optimal travel route and actual travel route according to one embodiment of the invention may be equal to the above predetermined level of benefits.

Next, the communication unit 240 according to one embodiment of the invention may function to enable data transmission/reception from/to the information acquisition unit 210, the recommended route provision unit 220, and the benefit determination unit 230.

Lastly, the control unit 250 according to one embodiment of the invention may function to control data flow among the information acquisition unit 210, the recommended route provision unit 220, the benefit determination unit 230, and the communication unit 240. That is, the control unit 250 according to the invention may control data flow into/out of the benefit provision system 200 or data flow among the respective components of the benefit provision system 200, such that the information acquisition unit 210, the recommended route provision unit 220, the benefit determination unit 230, and the communication unit 240 may carry out their particular functions, respectively.

FIG. 3 illustratively shows a situation in which benefits for an application are provided according to one embodiment of the invention.

Referring to FIG. 3, it may be assumed that first and second users desire to travel from different locations 301 and 306 to an identical destination 304, and items for a game application are provided as benefits when they visit a CGV cinema 305.

First, according to one embodiment of the invention, the benefit provision system 200 may acquire information on an optimal travel route 302 of the first user and an optimal travel route 307 of the second user.

Next, according to one embodiment of the invention, when the CGV cinema 305 is included in an actual travel route 303 of the first user, the benefit provision system 200 may determine a level of item benefits to be provided to the first user with reference to a difference between the optimal travel route 302 and the actual travel route 303 of the first user. Further, according to one embodiment of the invention, when the CGV cinema 305 is included in an actual travel route 307 of the second user, the benefit provision system 200 may determine a level of item benefits to be provided to the second user with reference to a difference between the optimal travel route 307 and the actual travel route 307 of the second user.

In this case, according to one embodiment of the invention, although the first and second users visited the same place associated with the benefits for the application (i.e., the CGV cinema 305), the level of item benefits to be provided to the first user (which is determined with reference to the difference between the optimal travel route 302 and the actual travel route 303 of the first user) may be determined to be greater than the level of item benefits to be provided to the second user (which is determined with reference to the difference between the optimal travel route 307 and the actual travel route 307 of the second user) because the second user visited the CGV cinema 305 while traveling through the optimal travel route 307, whereas the first user visited the CGV cinema 305 while traveling away from the optimal travel route 302 in order to receive the benefits provided from the CGV cinema 305.

Further, according to one embodiment of the invention, when determining the item benefits to be provided to the first and second users, the benefit provision system 200 may determine a CGV movie discount coupon (i.e., marketing information for the place associated with the benefits for the application) as marketing information to be provided to the first and second users together with the above item benefits.

Meanwhile, according to one embodiment of the invention, the level of item benefits to be provided to the first user (which is determined on the basis of the difference between the optimal travel route 302 and the actual travel route 303 of the first user) when the CGV cinema 305 is included in the actual travel route 303 of the first user on Jul. 27, 2017, and the level of item benefits to be provided to the first user (which is determined on the basis of the difference between the optimal travel route 302 and the actual travel route 303 of the first user) when the CGV cinema 305 is included in the actual travel route 303 of the first user on Jul. 28, 2017 may be differently determined according to predetermined levels of benefits provided from the CGV cinema 305 for the respective points of time.

The embodiments according to the invention as described above may be implemented in the form of program instructions that can be executed by various computer components, and may be stored on a computer-readable recording medium. The computer-readable recording medium may include program instructions, data files, data structures and the like, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing benefits for an application, the method comprising the steps of:
acquiring information on an optimal travel route of a user; and
when a place associated with benefits for at least one application is included in an actual travel route of the user, determining the benefits to be provided to the user with reference to a difference between the optimal travel route and the actual travel route.

2. The method of claim 1, further comprising the step of:
providing the user with information on a recommended travel route including the place associated with the benefits for the at least one application, with reference to the information on the optimal travel route of the user.

3. The method of claim 2, further comprising the step of:
predetermining the benefits to be provided to the user before the user actually travels, with reference to the recommended travel route.

4. The method of claim 1, wherein the benefits for the application include information on at least one of characters, items, coupons, discounts, service use, and service sharing.

5. The method of claim 1, wherein a level of the benefits increases as the difference between the optimal travel route and the actual travel route increases.

6. The method of claim 1, wherein in the determining step, the benefits to be provided to the user are determined with further reference to a point of time when the place associated with the benefits for the at least one application is included in the actual travel route.

7. The method of claim 1, wherein in the determining step, the benefits to be provided to the user are determined with further reference to a period of time for which the user stays in the place associated with the benefits for the at least one application.

8. The method of claim 1, wherein in the determining step, marketing information for the place is further determined which is to be provided together with the benefits.

9. A non-transitory computer-readable recording medium having stored thereon a computer program for executing the method of claim 1.

10. A system for providing benefits for an application, the system comprising:
an information acquisition unit configured to acquire information on an optimal travel route of a user; and
a benefit determination unit configured to, when a place associated with benefits for at least one application is included in an actual travel route of the user, determine the benefits to be provided to the user with reference to a difference between the optimal travel route and the actual travel route.
